(19) United States
(12) Patent Application Publication
(10) Pub. No.: US 2013/0064677 A1
(43) Pub. Date: Mar. 14, 2013

(54) ROTOR BLADE ASSEMBLY FOR WIND TURBINE

(71) Applicant: Xiomara Irizarry-Rosado, Greer, SC (US)

(72) Inventor: Xiomara Irizarry-Rosado, Greer, SC (US)

(73) Assignee: General Electric Company, Schenectady, NY (US)

(21) Appl. No.: 13/231,227

(22) Filed: Sep. 13, 2011

(51) Int. Cl. F03D 1/06

(52) U.S. Cl. 416/241 R; 416/223 R

(57) ABSTRACT

A rotor blade assembly for a wind turbine is disclosed. The rotor blade assembly includes a rotor blade having surfaces defining a pressure side, a suction side, a leading edge, and a trailing edge extending between a tip and a root. The surfaces further define an interior, and the rotor blade further defines a span and a chord. The rotor blade assembly further includes a strut disposed in the interior and extending between the pressure side and the suction side. A length of the strut extends in a generally spanwise direction, and a width of the strut extends diagonally to the chord.

### FIELD OF THE INVENTION

The present disclosure relates in general to rotor blade assemblies, and more particularly to rotor blade assemblies having internal structures designed to reduce buckling.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The particular size of wind turbine rotor blades is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, as rotor blade sizes increase, the weights of the blades also increase. Such increased weight can subject a rotor blade to a high risk of buckling, especially during operation of the wind turbine. Buckling of a rotor blade can cause damage or potentially catastrophic destruction of the rotor blade and/or wind turbine.

Current attempts to reduce the risk of buckling in a rotor blade have included, for example, increasing the strength of the rotor blade spar caps and/or shear webs. However, such increases in strength require corresponding increases in size and weight.

Accordingly, an improved rotor blade assembly for a wind turbine would be desired in the art. For example, a rotor blade assembly that included an internal structure designed to decrease buckling would be advantageous.

### BRIEF DESCRIPTION OF THE INVENTION

Aspects and advantages of the invention will be set forth in part in the following description, or may be obvious from the description, or may be learned through practice of the invention.

In one embodiment, a rotor blade assembly for a wind turbine is disclosed. The rotor blade assembly includes a rotor blade having surfaces defining a pressure side, a suction side, a leading edge, and a trailing edge extending between a tip and a root. The surfaces further define an interior, and the rotor blade further defines a span and a chord. The rotor blade assembly further includes a strut disposed in the interior and extending between the pressure side and the suction side. A length of the strut extends in a generally spanwise direction, and a width of the strut extends diagonally to the chord.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 is a top view of a rotor blade assembly according to one embodiment of the present disclosure;

FIG. 3 is a cross-sectional view of a rotor blade assembly according to one embodiment of the present disclosure;

FIG. 4 is a cross-sectional view of a rotor blade assembly according to another embodiment of the present disclosure;

FIG. 5 is a cross-sectional view of a rotor blade assembly according to another embodiment of the present disclosure; and,

FIG. 6 is a cross-sectional view of a rotor blade assembly according to another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

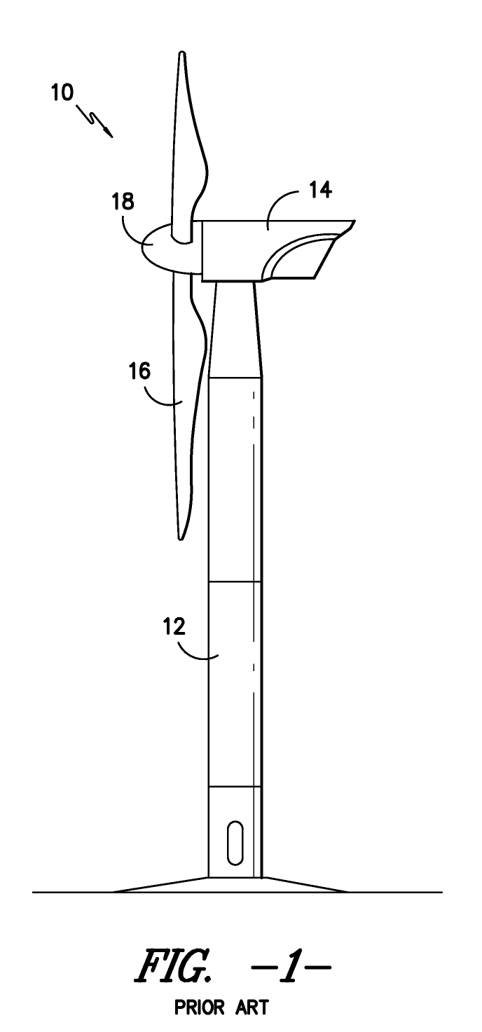

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

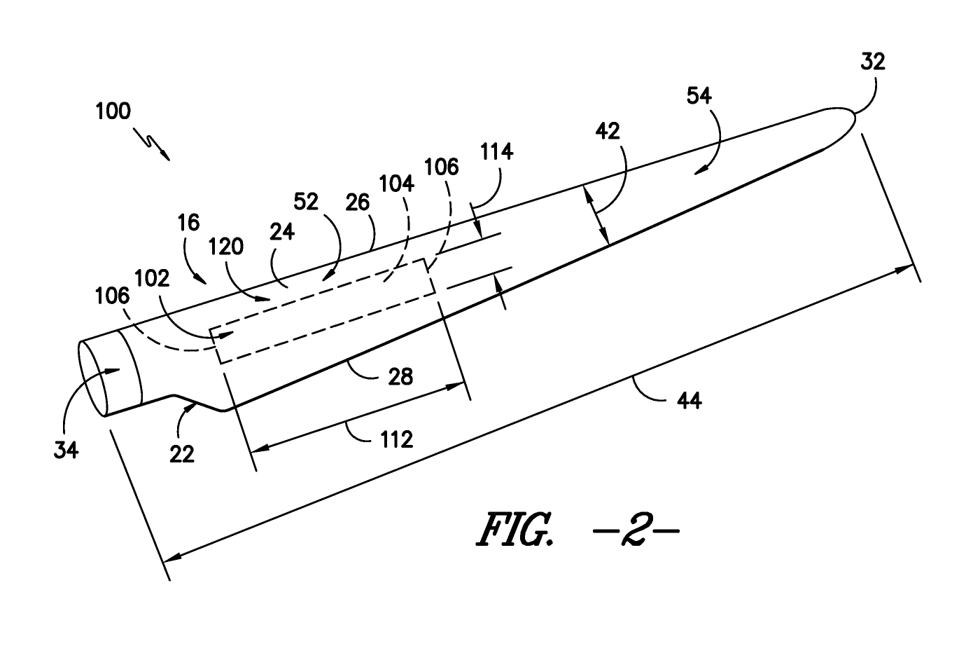

Referring to FIG. 2, a rotor blade 16 according to the present disclosure may include exterior surfaces defining a pressure side 22 and a suction side 24 (see FIGS. 3 through 5) extending between a leading edge 26 and a trailing edge 28, and may extend from a blade tip 32 to a blade root 34. The pressure side 22 and suction side 24 meet at, and thus define, the leading edge 26 and trailing edge 28. The exterior surfaces may be generally aerodynamic surfaces having generally aerodynamic contours, as is generally known in the art.

In some embodiments, the rotor blade 16 may include a plurality of individual blade segments aligned in an end-to-end order from the blade tip 32 to the blade root 34. Each of the individual blade segments may be uniquely configured so that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flapwise direction and/or in a generally edgewise direction. The flapwise direction may generally be construed as the direction (or the opposite direction) in which the aerodynamic lift acts on the rotor blade 16. The edgewise direction is generally perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

The rotor blade 16 may further define chord 42 and a span 44. As shown in FIG. 2, the chord 42 may vary throughout the span 44 of the rotor blade 16. Thus, a local chord may be defined for the rotor blade 16 at any point on the rotor blade 16 along the span 44.

Additionally, the rotor blade 16 may define an inboard area 52 and an outboard area 54. The inboard area 52 may be a span-wise portion of the rotor blade 16 extending from the root 34. For example, the inboard area 52 may, in some embodiments, include approximately 33%, 40%, 50%, 60%, 67%, or any percentage or range of percentages therebetween, or any other suitable percentage or range of percentages, of the span 44 from the root 34. The outboard area 54 may be a span-wise portion of the rotor blade 16 extending from the tip 32, and may in some embodiments include the remaining portion of the rotor blade 16 between the inboard area 52 and the tip 32. Additionally or alternatively, the outboard area 54 may, in some embodiments, include approximately 33%, 40%, 50%, 60%, 67%, or any percentage or range of percentages therebetween, or any other suitable percentage or range of percentages, of the span 44 from the tip 32.

As shown in FIGS. 3 through 6, the surfaces of the rotor blade 16 may further define an interior 60 of the rotor blade 16. The interior 60 is thus the cavity inside of the rotor blade 16 and surrounded by the various surface.

In some embodiments, spar caps (not shown) may be included in one or more of the external surfaces. Typically, for example, one or more spar caps may be included in the pressure side 22 and suction side 24. The spar caps typically serve as structural members, and thus may be relatively thicker or formed from a different material than the remainder of the surfaces of the rotor blade 16.

As shown in FIGS. 2 through 6, the present disclosure may further be directed to a rotor blade assembly 100. The rotor blade assembly 100 may include a rotor blade 16. Further, the rotor blade assembly 100 includes structural features disposed in the interior 60 of the rotor blade 16. Such structural features are positioned to prevent or reduce buckling and/or other undesirable bending of the rotor blade 16, and may thus stiffen and/or strengthen the rotor blade 16. Buckling and other undesirable bending may occur in the flapwise direction or the edgewise direction, and/or about the chord 42 or span 44, or in or about any other suitable direction or axis.

Thus, as shown in FIGS. 3 through 6, the rotor blade assembly 100 may include one or more struts 102. Each strut 102 may be disposed in the interior 60 of the rotor blade 16, and may extend between the pressure side 22 and suction side 24 of the rotor blade 16. A strut may include a body 104 extending between two ends 106 (only one of which is shown in the cross-sectional views of FIGS. 3 through 6). The strut may typically have a generally rectangular cross-sectional profile, as shown. It should be understood, however, that the present disclosure is not limited to rectangular cross-sectional profiles, and rather that any suitable cross-sectional profile is within the scope and spirit of the present disclosure.

The orientation of each strut within the interior 60 may advantageously reduce the risk of bucking or other undesirable bending of the rotor blade 16. A strut 102 according to the present disclosure thus has a length 112, a width 114, and a thickness 116. The length 112 extends in the generally spanwise direction, along the span 44. Thus, the ends 106 are spaced apart along the span 44. In some embodiments, the length 112 of the strut 102 may extend through the entire span 44, from the root 34 to the tip 32. In other embodiments, the length 112 may extend through only a portion of the span 44.

For example, a high buckling region 120 may be defined for the rotor blade assembly 100. The high buckling region is a region of the rotor blade 16 that is relatively more likely than other regions of the rotor blade 16 to buckle. The strut 102, or a portion thereof, may extend through all or a portion of the high buckling region, thus reducing the risk of buckling in this region. The high buckling region may be the region between approximately 0% and approximately 50% of the span 44 from the root 34, or between approximately 5% and approximately 40% of the span 44 from the root 34, or between approximately 10% and approximately 30% of the span 44 from the root 34, or any other span-wise region of the rotor blade 16 that is relatively more likely than other regions of the rotor blade 16 to buckle.

The present inventors have discovered that the orientation of the width 114 relative to the chord 42 is particularly advantageous in reducing the risk of buckling. Thus, the width 114 of the strut 102 extends diagonally to the chord 42, and may further extend diagonally to an axis 122. The axis 122 is defined perpendicularly to both chord 42 and span 44, and thus extends between the pressure side 22 and suction side 24. “Diagonally” according to the present disclosure means at an angle to the chord 42 and/or the axis 122. Thus, an angle 124 may be defined with respect to the chord 42, as shown. A width 114 of the strut 102 extending diagonally is at an angle 124 that is less than 90 degrees and greater than 0 degrees.

In some embodiments, the width 114 may extend at an angle 124 in the range between approximately 20 degrees and approximately 80 degrees from the chord 42, such as in the range between approximately 30 degrees and approximately 70 degrees from the chord 42, such as in the range between approximately 40 degrees and approximately 50 degrees from the chord 42, such as approximately 45 degrees from the chord 42.

As mentioned, the strut 102, such as the width 114 thereof, extends between the pressure side 22 and suction side 24. In some embodiments, the strut 102 may be connected to a surface or surfaces defining the pressure side 22 and/or suction side 24 through any suitable connection apparatus. For example, in some embodiments, suitable mechanical fasteners, such as nails, screws, nut-bolt combinations, rivets, or other suitable mechanical fasteners may be utilized, or the struts 102 may be adhered using a suitable adhesive. In other embodiments, the strut 102 may, for example, be connected to a shear web 130 or other suitable component of the rotor blade 16. Further, in some embodiments, the strut 102 may abut the shear webs 130 or surfaces defining the pressure side 122 and/or suction side 24, and may be connected thereto or connected to other such components.

As further shown in FIGS. 3 through 5, in some embodiments one or more shear webs 130 may be included in the interior of the rotor blade 16 extending between the pressure side 22 and the suction side 24. The shear webs 130 may, for example, extend between pressure side and suction side spar caps, or otherwise between the pressure side 22 and suction side 24. Each shear web 130, as shown, extends along the axis 122 that is perpendicular to the chord 42 and span 44. The shear webs 130 are generally formed from fiberglass, balsa wood, and/or foam. Further, in many typical rotor blades, each shear web 130 has a thickness 132 of between approximately 0.5 inches and approximately 5 inches, between approximately 1 inch and approximately 3 inches, or approximately 2 inches.

The struts 102 according to the present disclosure may similarly be formed from a suitable material such as fiberglass, balsa wood, and/or foam. Alternatively, the struts 102 may be formed from carbon, such as carbon fiber, or any other suitable lightweight composite.

In some embodiments, the thickness 116 of a strut 102 may be less than the thickness 132 of a shear web 130. For example, the thickness 116 may in some embodiments be two-thirds, one-half, or one-third of the thickness 132.

Thus, the struts 102 may advantageously provide stability to the rotor blade 16 and prevent buckling and other undesirable bending of the rotor blade 16 while remaining lightweight and relatively thin. Thus, increases to the weight and bulk of the rotor blade 16 are relatively small.

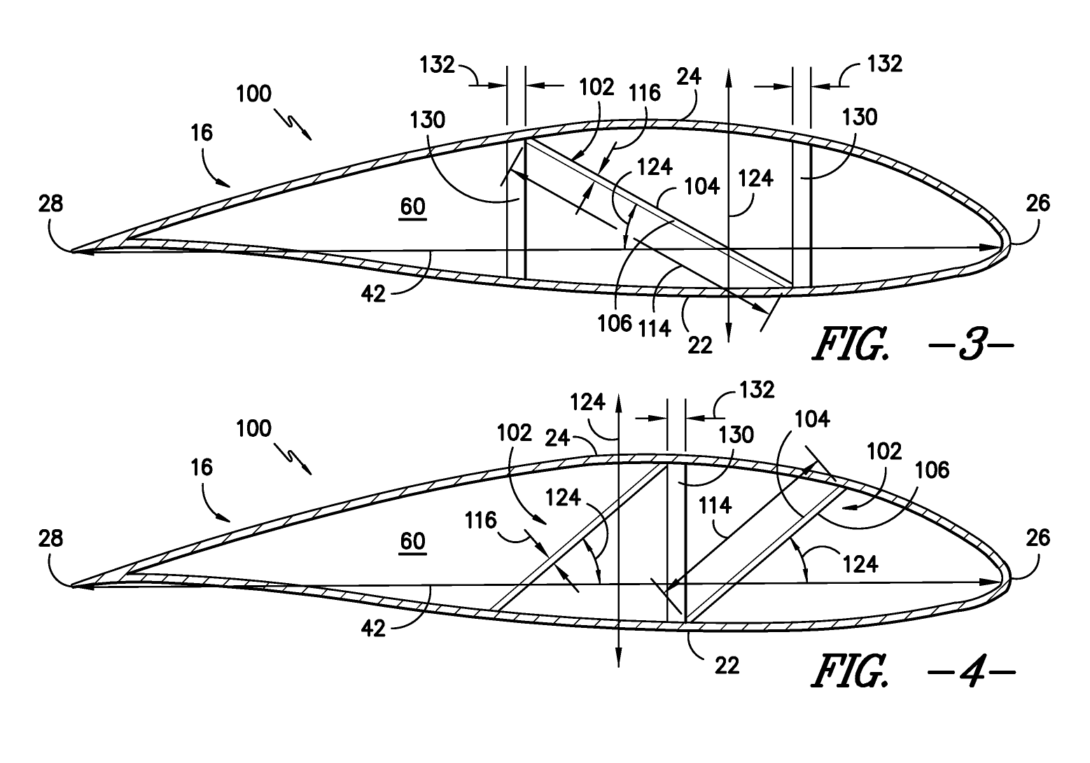

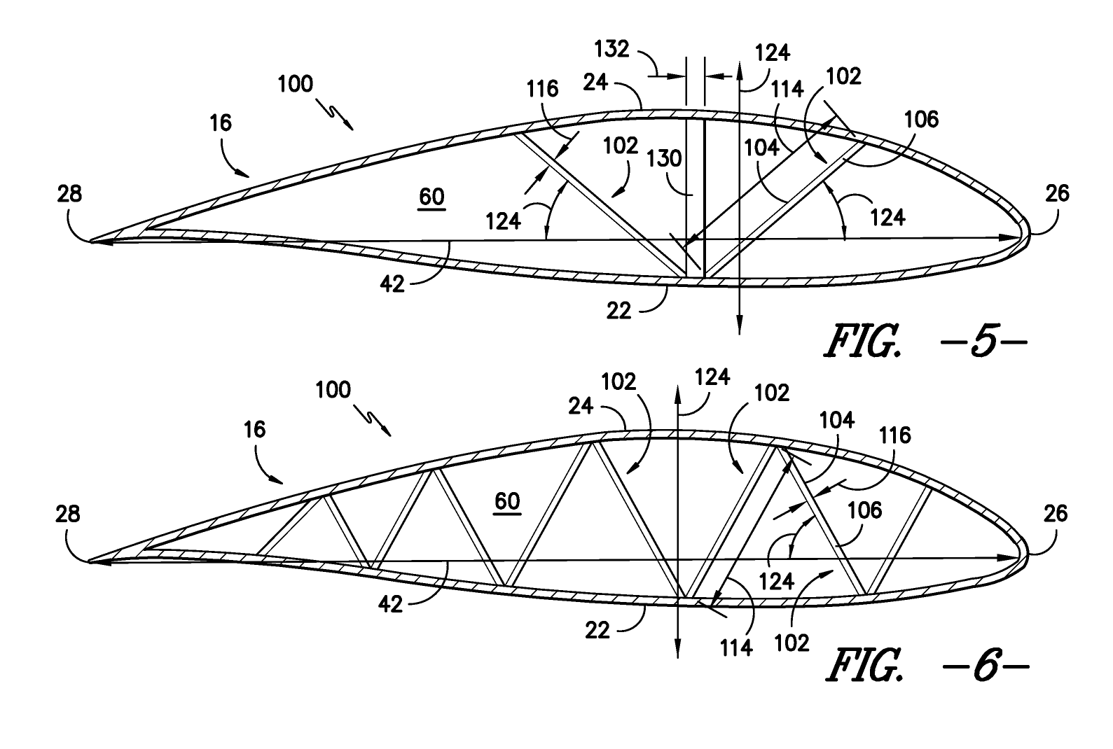

FIGS. 3 through 6 illustrate various embodiments of a rotor blade assembly 100 according to the present disclosure. For example, FIG. 3 illustrates a strut 102 extending diagonally between two shear webs 130. FIG. 4 illustrates two struts 102 extending diagonally from a single shear web 130. FIG. 5 illustrates another embodiment of two struts 102 extending diagonally from a single shear web 130. FIG. 6 illustrates nine struts 102 extending diagonally within the interior 60, and without shear webs 130 in the interior 60. It should be understood that any number of struts 102 may be disposed in the interior 60, and further that the struts 102 may be positioned along the entire chord 42, as shown in FIG. 6, or along any portion thereof, as shown in FIGS. 3 through 5.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly for a wind turbine, comprising:
a rotor blade having surfaces defining a pressure side, a suction side, a leading edge, and a trailing edge extending between a tip and a root, the surfaces further defining an interior, the rotor blade further defining a span and a chord; and,
a strut disposed in the interior and extending between the pressure side and the suction side,
wherein a length of the strut extends in a generally spanwise direction and a width of the strut extends diagonally to the chord.

2. The rotor blade assembly of claim 1, wherein the width of the strut further extends diagonally to an axis perpendicular to the span and the chord.

3. The rotor blade assembly of claim 1, wherein the width extends at an angle in the range between approximately 20 degrees and approximately 80 degrees from the chord.

4. The rotor blade assembly of claim 1, wherein the width extends at an angle in the range between approximately 40 degrees and approximately 50 degrees from the chord.

5. The rotor blade assembly of claim 1, wherein the strut is disposed in a high buckling region of the rotor blade.

6. The rotor blade assembly of claim 5, wherein the high buckling region is between approximately 5% and approximately 40% of the span from the root.

7. The rotor blade assembly of claim 5, wherein the high buckling region is between approximately 10% and approximately 30% of the span from the root.

8. The rotor blade assembly of claim 1, further comprising a plurality of struts.

9. The rotor blade assembly of claim 1, further comprising a shear web extending between the pressure side and the suction side generally along the axis perpendicular to the span and the chord.

10. The rotor blade assembly of claim 9, wherein a thickness of the strut is less than a thickness of the shear web.

11. A wind turbine, comprising:
a plurality of rotor blades, at least one of the plurality of rotor blades having surfaces defining a pressure side, a suction side, a leading edge, and a trailing edge extending between a tip and a root, the surfaces further defining an interior, the at least one of the plurality of rotor blades further defining a span and a chord; and,
a strut disposed in the interior and extending between the pressure side and the suction side of the at least one of the plurality of rotor blades,
wherein a length of the strut extends in a generally spanwise direction and a width of the strut extends diagonally to the chord.

12. The wind turbine of claim 11, wherein the width of the strut further extends diagonally to an axis perpendicular to the span and the chord.

13. The wind turbine of claim 11, wherein the width extends at an angle in the range between approximately 20 degrees and approximately 80 degrees from the chord.

14. The wind turbine of claim 11, wherein the width extends at an angle in the range between approximately 40 degrees and approximately 50 degrees from the chord.

15. The wind turbine of claim 11, wherein the strut is disposed in a high buckling region of the rotor blade.

16. The wind turbine of claim 15, wherein the high buckling region is between approximately 5% and approximately 40% of the span from the root.

17. The wind turbine of claim 15, wherein the high buckling region is between approximately 10% and approximately 30% of the span from the root.

18. The wind turbine of claim 11, further comprising a plurality of struts.

19. The wind turbine of claim 11, further comprising a shear web extending between the pressure side and the suction side generally along the axis perpendicular to the span and the chord.

20. The wind turbine of claim 19, wherein a thickness of the strut is less than a thickness of the shear web.

21. The wind turbine of claim 11, wherein the strut is formed from fiberglass.
